(19) United States
(12) Patent Application Publication
(10) Pub. No.: US 2008/0280656 A1
(43) Pub. Date: Nov. 13, 2008

(54) Power management unit (PMU) sequencer

(75) Inventors: Mark Gonikberg, Los Altos Hills, CA (US); Jay Pattin, Waban, MA (US); Wai Ki (Keno) Yeung, San Jose, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/801,326

(22) Filed: May 9, 2007

(51) Int. Cl. H04B 1/38; H04B 7/00

(52) U.S. Cl. 455/572; 455/522

(57) ABSTRACT

A technique to use a power management unit (PMU) sequencer to control switching of a plurality of functional modules between two or more power modes. The PMU sequencer sequences through a hierarchical order of turn-on and turn-off sequences based on dependencies established for each of the functional modules. In addition to the dependencies, turn-on and turn-off delay times are established for each of the functional modules.

### BACKGROUND OF THE INVENTION

1. Technical Field of the Invention

The embodiments of the invention relate to communication devices and more particularly to a power management scheme in a wireless device.

2. Description of Related Art

Communication systems are known to support wireless and wire lined communications between wireless and/or wire lined communication devices. Such communication systems range from national and/or international cellular telephone systems to the Internet to point-to-point in-home wireless networks. Communication systems typically operate in accordance with one or more communication standards. For instance, wired communication systems may operate according to one or more versions of the Ethernet standard, the System Packet Interface (SPI) standard, or various other standards. Wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). Typically, the transceiver includes a data modulation stage and an RF stage. The data modulation stage (baseband process) converts between data and baseband signals in accordance with the particular wireless communication standard. The RF stage (transmitter section and receiver section) converts between baseband signals and RF signals. The RF stage may be a direct conversion transceiver that converts directly between baseband and RF or may include one or more intermediate frequency stages.

Most wireless communication devices are designed to operate as portable devices, so that they are typically powered by a battery. For small handheld devices, the small size of the battery usually places significant power limitations on the operation of the particular device. Accordingly, many portable wireless devices implement some form of power management scheme where the device is placed into a sleep state, until there is some user initiated action or until a signal is received. As wireless devices become more computational intensive, with many more functions being added to a device, power management becomes more paramount. The simple power ON/OFF or the alternative ON/STAND-BY (also, ON/SLEEP) modes of power management control used with earlier wireless devices is generally inadequate for controlling the power drain of devices having multitude of functions. The simple ON/OFF modes, where ON is a full power state and OFF is a no power or some reduced power state (e.g. STAND-BY or SLEEP) in which one or more functional components are placed into some non-functional state, is no longer an adequate technique for maintaining optimal power management.

From a system level, current and future systems may contain a large number of functional components, such as processors, memories, interfaces, radios, physical layers (PHYs), power regulators, crystal oscillators, just to name a few. Furthermore, these various functional components may operate in different power modes (not just the power ON, power OFF states), wherein a given mode may have different power consumption properties or requirements within a system, and in which a given operating mode may depend on a corresponding functionality associated with the device. To reduce power consumption, as well as the resulting heat generation, it is advantageous to place the functional components into their lowest power mode that may still support a required activity. In complex systems, the power mode transition may happen at different times and there may be a complex set of dependencies between the various components. Furthermore, switching between the various power modes and/or the functional components may entail different timing requirements.

Accordingly, it would be advantageous to implement a power management scheme in which a more detailed sequence of controls is placed on the various functional components with intertwined dependencies.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE SEVERAL VIEWS OF THE DRAWINGS

FIG. 1 is a block diagram illustrating a wireless communication system in accordance with one embodiment of the present invention.

FIG. 2 is a block schematic block diagram illustrating a wireless communication device in accordance with one embodiment of the present invention.

FIG. 3 is a block schematic diagram illustrating one example system in which a PMU sequencer is employed to provide power management according to one embodiment of the invention.

FIG. 4 is a table showing a hierarchical ordering of power dependencies for resources of the system shown in FIG. 3 and corresponding timing values associated with power-up and power-down delays.

FIG. 5A shows one embodiment of using bit states in a register to designate one of two power mode states for the resources listed in FIG. 4.

FIG. 5B shows one embodiment of coupling the bit states in the register of FIG. 4 with a resource request signal.

FIG. 6 shows a state diagram to transition between enable and disable states for a resource using the delays shown in FIG. 4.

### DETAILED DESCRIPTION OF THE EMBODIMENTS OF THE INVENTION

The embodiments of the present invention may be practiced in a variety of settings that implement a power management scheme in which power up and power down sequences are determined by various dependencies imposed on resources within a wireless device.

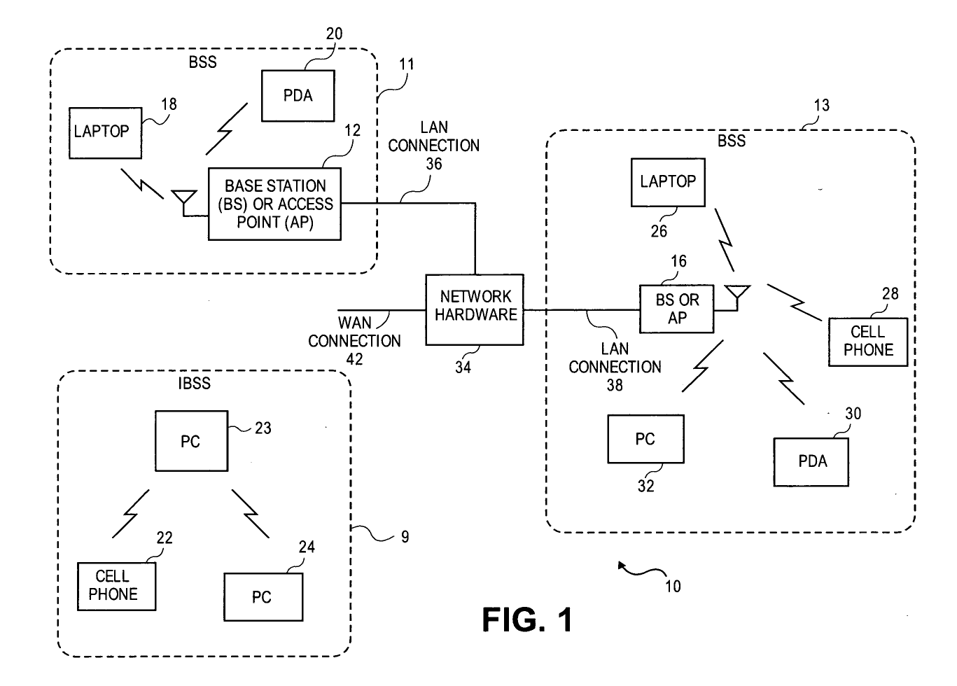

FIG. 1 is a block schematic diagram illustrating a communication system 10 that includes a plurality of base stations and/or access points 12, 16, a plurality of wireless communication devices 18-32 and a network hardware component 34. Network hardware 34, which may be a router, switch, bridge, modem, system controller, et cetera, provides a wide area network connection 42 for the communication system 10. Wireless communication devices 18-32 may be laptop host computers 18 and 26, personal digital assistant hosts 20 and 30, personal computer hosts 24 and 32 and/or cellular telephone hosts 22 and 28, as well as other devices.

Wireless communication devices 22, 23, and 24 are located within an independent basic service set (IBSS) area and communicate directly (i.e., point to point). In this configuration, these devices 22, 23, and 24 typically only communicate with each other. To communicate with other wireless communication devices within system 10 or to communicate outside of system 10, devices 22, 23, and/or 24 affiliate with one of the base stations (BS) or access points (AP).

Base stations or access points 12, 16 are located within basic service set (BSS) areas 11 and 13, respectively, and are coupled to network hardware 34 via one or more of local area network (LAN) connections 36, 38. Such a connection provides base station or access point 12, 16 with connectivity to other devices within system 10 and may also provide connectivity to other networks via a wide area network (WAN) connection 42. To communicate with the wireless communication devices within its BSS 11 or 13, each of the base stations or access points 12; 16 has an associated antenna or antenna array. For instance, base station or access point 12 wirelessly communicates with wireless communication devices 18 and 20 while base station or access point 16 wirelessly communicates with wireless communication devices 26, 28, 30, 32. Typically, the wireless communication devices register with a particular base station or access point 12, 16 to operate within communication system 10.

Typically, base stations are used for cellular telephone systems and like-type systems, while access points are used for in-home or in-building wireless networks. Regardless of the particular type of communication system, each wireless communication device includes a built-in radio and/or is coupled to a radio. The radio includes a highly linear amplifier and/or programmable multi-stage amplifiers to enhance performance, reduce costs, reduce size, and/or enhance broadband applications.

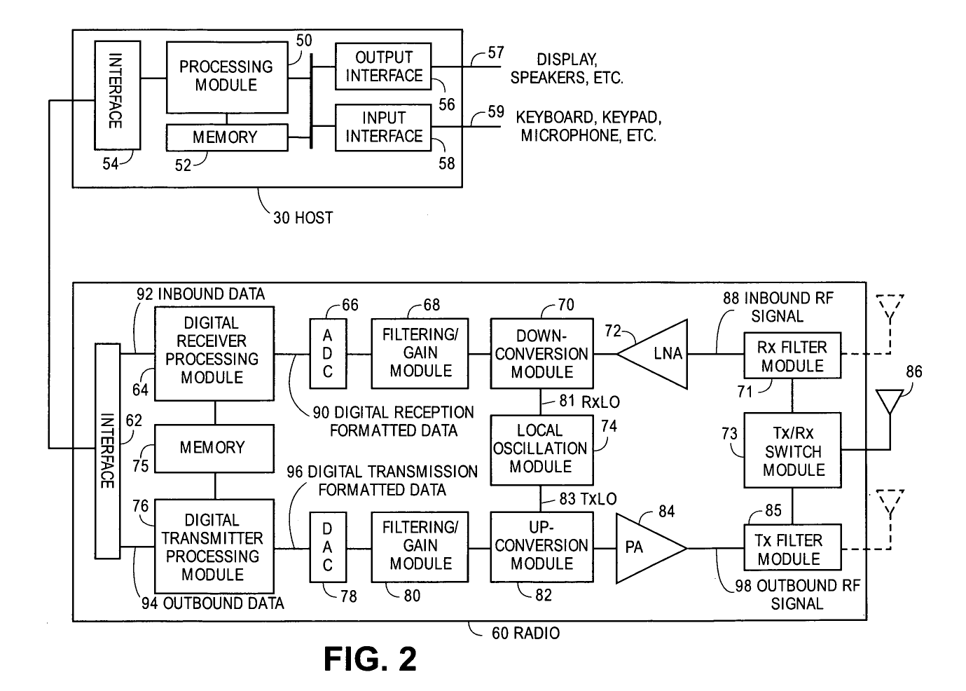

FIG. 2 is a schematic block diagram illustrating a wireless communication device that includes a host unit 30 and an associated radio unit 60. Host unit 30 may be incorporated in a communication device, such as one or more of the wireless communication devices shown in FIG. 1. For cellular telephone hosts, radio 60 is typically a built-in component. For personal digital assistants hosts, laptop hosts, and/or personal computer hosts, radio 60 may be built-in or may be an externally coupled component that couples to host device 30 via a communication link, such as a PCI interface, PCMCIA interface, USB interface, or another type of interface.

As illustrated, host device 30 includes a processing module 50, memory 52, radio interface 54, input interface 58, and output interface 56. Processing module 50 and memory 52 execute corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For inbound data received from radio 60, radio interface 54 provides the data to processing module 50 for further processing and/or routing to output interface 56. Output interface 56 provides connectivity to an output display device 57, such as a display, monitor, speakers, et cetera, such that the received data may be displayed or otherwise output. Radio interface 54 also provides outbound data from processing module 50 to radio 60. Processing module 50 may receive the outbound data from an input device 59, such as a keyboard, keypad, microphone, et cetera, via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter (ADC) 66, a filtering/gain/attenuation module 68, an intermediate frequency (IF) mixing down conversion stage noted as down-conversion module 70, a receiver filter module 71, a low noise amplifier (LNA) 72, a transmitter/receiver (Tx/Rx) switch module 73, a local oscillation module 74, a memory 75, a digital transmitter processing module 76, a digital-to-analog converter (DAC) 78, a filtering/gain/attenuation module 80, an IF mixing up conversion stage noted as up-conversion module 82, a power amplifier (PA) 84, a transmitter filter module 85, and an antenna 86. The antenna 86 may be a single antenna that is shared by the transmit and receive paths as controlled by Tx/Rx switch 73, or may include separate antennae for the transmit path and receive path (shown by the dotted line). The antenna implementation may depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, digital intermediate frequency to baseband conversion, demodulation, constellation demapping, decoding, and/or descrambling. The digital transmitter functions include, but are not limited to, scrambling, encoding, constellation mapping, modulation, and/or digital baseband to IF conversion. Digital receiver and transmitter processing modules 64 and 76 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when processing module 64 and/or 76 implements one or more of its functions via a state machine, analog circuitry, digital circuitry, and/or logic circuitry, the memory storing the corresponding operational instructions may be embedded with the circuitry comprising the state machine, analog circuitry, digital circuitry, and/or logic circuitry. Memory 75 stores, and the processing module 64 and/or 76 executes, operational instructions that facilitate functionality of the device. In some embodiments, the combination of digital receiver processing module 64, digital transmitter processing module 76 and memory 75 may be referred to together as a “baseband processor.”

In operation, radio 60 receives outbound data 94 from host 30 via host interface 62. Host interface 62 routes outbound data 94 to digital transmitter processing module 76, which processes outbound data 94 in accordance with a particular wireless communication standard (e.g., IEEE802.11a, IEEE802.11b, IEEE802.11g, Bluetooth, et cetera) to produce digital transmission formatted data 96. Digital transmission formatted data 96 is typically a digital base-band signal or a digital low IF signal, where the low IF typically may be in the frequency range of one hundred kilohertz to a few megahertz (MHz).

Digital-to-analog converter 78 converts digital transmission formatted data 96 from the digital domain to the analog domain. Filtering/gain/attenuation module 80 filters and/or adjusts the gain of the analog signal prior to providing it to up-conversion module 82 for mixing. Up-conversion module 82 directly converts the analog baseband or low IF signal into an RF signal based on a transmitter local oscillation (Tx LO) 83 provided by local oscillation module 74. Power amplifier 84 amplifies the RF signal to produce outbound RF signal 98, which is filtered by transmitter filter module 85. Antenna 86 propagates outbound RF signal 98 to a targeted device such as a base station, an access point and/or another wireless communication device.

Radio 60 also receives inbound RF signal 88 via antenna 86, which was transmitted by a base station, an access point, or another wireless communication device. Antenna 86 provides inbound RF signal 88 to receiver filter module 71 via Tx/Rx switch 73, where Rx filter 71 bandpass filters inbound RF signal 88. Rx filter 71 provides the filtered RF signal to low noise amplifier 72, which amplifies signal 88 to produce an amplified inbound RF signal. The low noise amplifier 72 provides the amplified inbound RF signal to down-conversion module 70, which directly converts the amplified inbound RF signal into an inbound low IF signal or baseband signal based on a receiver local oscillation (Rx LO) 81 provided by local oscillation module 74. Down-conversion module 70 provides the inbound low IF signal or baseband signal to filtering/gain/attenuation module 68. Filtering/gain/attenuation module 68 may be implemented to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to host device 30 via radio interface 54.

As one of ordinary skill in the art will appreciate, the particular wireless communication device of FIG. 2 may be implemented using one or more integrated circuits. For example, host 30 may be implemented on one integrated circuit and digital receiver processing module 64, digital transmitter processing module 76 and memory 75 may be implemented on a second integrated circuit, and the remaining components of radio 60, less the antenna 86, may be implemented on a third integrated circuit. As an alternative embodiment, radio 60 may be implemented on a single integrated circuit. As yet another alternative embodiment, processing module 50 of host 30 and digital receiver and transmitter processing modules 64 and 76 may be a common processing device implemented on a single integrated circuit. Further, memory 52 and memory 75 may be implemented on a single integrated circuit and/or on the same integrated circuit as the common processing modules of processing module 50 and digital receiver and transmitter processing module 64 and 76. Generally, radio 60 is defined as having a baseband portion and a RF portion.

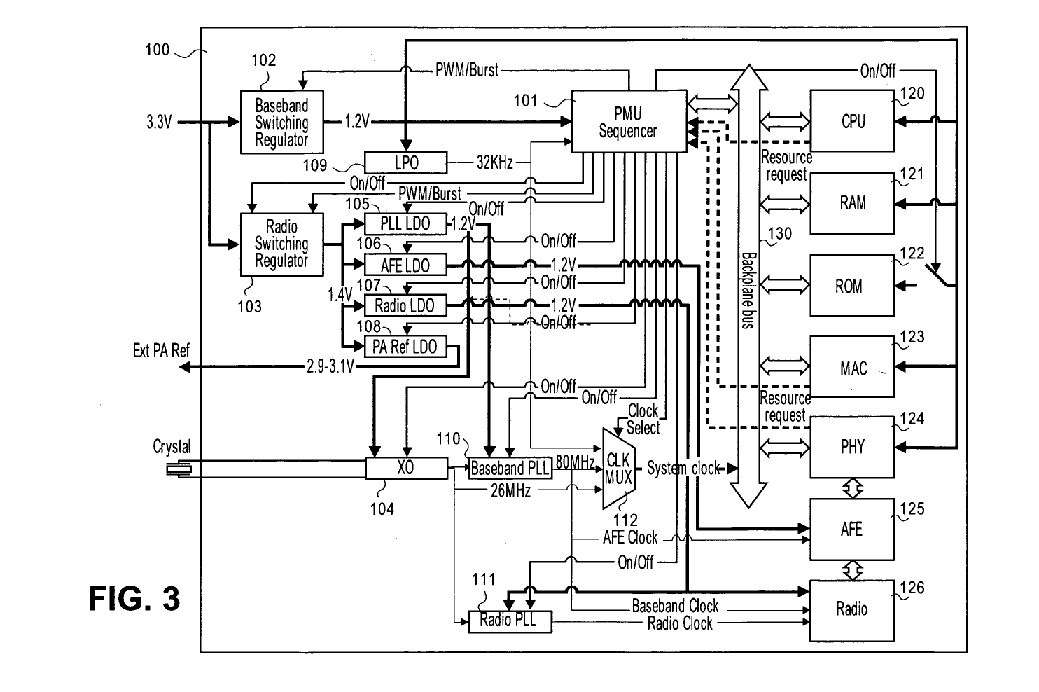

FIG. 3 shows a system diagram of a wireless system 100, in which one embodiment of a Power Management Unit (PMU) sequencer 101 is employed within system 100. System 100 may be one integrated circuit chip, such as a system-on-chip (SoC), or it may comprise a plurality of integrated circuit chips. System 100 may be included within one of the wireless devices noted in FIG. 1. Furthermore, in another embodiment, system 100 may include radio 60 or the combination of both host 30 and radio 60 of FIG. 2. It is to be noted that various other systems may be implemented to practice the embodiments of the invention. The particular system illustrated in FIG. 3 is but one example of the functionality present in a wireless device in which a PMU sequencer is present to manage power control for the system.

System 100 includes a number of components that provide various functions and the components are referred to as functional modules or functional blocks. The functional modules maybe hardware, software, firmware or a combination thereof. It is appreciated that other systems may have more or less functional modules than shown in system 100. Furthermore, only those functional modules that pertain to power management by PMU sequencer 101 are shown in FIG. 3. Thus, system 100 includes a baseband switching regulator module 102, which receives an incoming power supply voltage. In some instances, this may be a battery voltage, VBat. In the particular example, the input supply voltage is approximately 3.3 volts. Baseband switching regulator module 102 generates a regulated supply voltage (e.g. approximately 1.2 V) to power baseband components of system 100. Likewise, the 3.3 V supply is also coupled to a radio switching regulator module 103. Radio switching regulator module 103 generates a regulated supply voltage (e.g. approximately 1.4 V) to power the radio components.

The various baseband functional modules shown include low power oscillator (LPO) module 109, central processing unit (CPU) module 120, random-access memory (RAM) module 121, read-only memory (ROM) module 122, media access control (MAC) module 123, physical layer (PHY) module 124, as well as PMU sequencer 101. The 1.2 V supply from regulator module 102 are coupled to these baseband functional modules, as noted in FIG. 3.

The various radio functional modules shown include analog front-end (AFE) module 125, radio module 126, AFE low dropout regulator (LDO) module 106, radio LDO module 107, radio phase locked-loop (PLL) module 111 and power amplifier (PA) reference LDO module 108. Regulator module 103 also provides supply voltage to PLL LDO module 105, which supply output is provided to a crystal oscillator (XO) module 104 and to baseband PLL module 110. The various LDO supply outputs are coupled to corresponding operating modules as shown in FIG. 3. The power amplifier is shown external to system 100, but in other embodiments, a PA may be included within system 100. Likewise, a crystal is shown external to system 100, but such crystal to set the frequency of XO module 104 may be included within system 100. A backplane bus 130 is also shown within system 100, as well as a clock multiplexer (CLK MUX) 112, which selects a particular clock signal as a system clock.

Aside from the power supply lines, FIG. 3 also shows clock signal lines to and from the various functional modules, resource request lines (shown dotted) and control lines from PMU sequencer 101 to various functional modules. Three resource request lines are shown; each from CPU 120, MAC 123 and PHY 124, but other embodiments may have other combinations of functional modules that generate such requests. The resource request lines are used to request one or more resources by the requester for a particular functionality. As noted below, a resource is an active mode (or one of the active modes, if more than one active mode is present) of a functional module.

The control lines from PMU sequencer 101 are used to control operation of the various corresponding resources and in the particular example shown for system 100, the control lines from PMU sequencer 101 to the modules are used to turn on or turn off a particular mode of operation. The ON/OFF designation is used herein and in some instances the ON/OFF designation may actually turn on or turn off power related to a particular resource. However, in the context described below, the ON/OFF designation is used to place the resources into a particular power mode or exit the resource from a particular power mode. For example, the particular mode may switch the resource between a high voltage state and a lower voltage state. In other instances, power modes may determine an activation/deactivation of a clock signal or switching between different clock rates. Still, other modes may be determined by type of signals, such as burst mode and pulsewidth modulation mode. Thus, the ON/OFF designation is used to identify an enabled (ON) state of a resource and disabled (OFF) state of a resource. As will be noted below, the particular functional module may have more than one power mode state, wherein PMU sequencer 101 control lines may cause a functional module to disable one operational state and enable another operational state.

PMU sequencer 101 is used to control the power consumption of system 100. On a system level, power control is accomplished by defining various power save modes where periods of activity (full functionality) are alternated with dormant periods (reduced functionality). The switching between the active and dormant states may be due to timing or based on a system activity metric. Furthermore, the power mode transition may happen at different times. For example, in a wireless local access network (WLAN) system, MAC module 123 may be turned off while PHY module 124 and radio module 126 are waiting for the data packet. Once the packet arrives, MAC module 123 is powered on to process the packet, but PHY module 124 in turn may be turned off, if it is known that the next radio activity will not happen for some time. Thus, a number of scenarios may be developed for system 100 in which power management to the various functional modules may have dependencies to other resources. This may be complicated if the various resources have different time requirements to turn on or turn off.

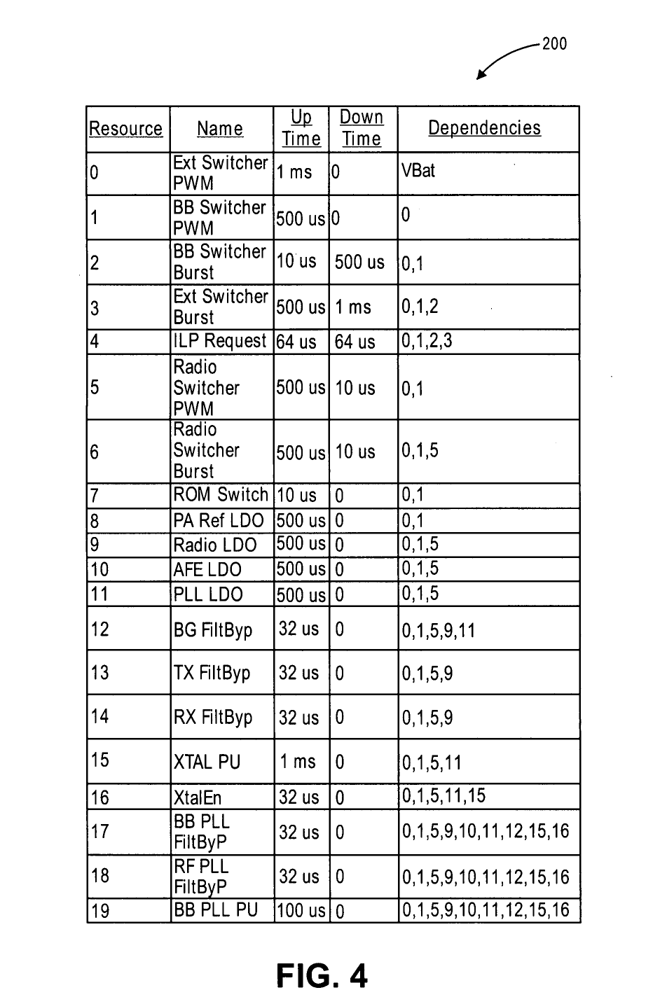

In order to provide complex power management, PMU sequencer 101 controls the power to the various resources of the functional modules, based on requests from certain core requesting resources. PMU sequencer 101 employs dependencies among the resources and these dependencies are used for determining which resources are to be turned on and which are to be turned off. PMU sequencer 101 includes a dependency table, where an i-th entry corresponds to the i-th resource. FIG. 4 shows one embodiment for such a dependency table.

In FIG. 4, dependency table 200 lists a number of resource entries that correspond to the various functional modules shown in system 100. Each entry is associated with a control signal to the corresponding resource. Multiple operational modes for a functional module, such as Burst mode and PWM, are listed as separate resources (thus, separate entries) in table 200.

Thus, entries 1 and 2 are controls to baseband switching regulator module 102, in which entry 1 pertains to pulsewidth modulation (PWM) mode of operation and entry 2 pertains to burst mode of operation. Likewise, entries 5 and 6 are controls to radio switching regulator module 103 for PWM and burst modes, respectively.

Table 200 is shown having a resource number or identification (ID) in the first column, with the resource name in the second column. Column three for an i-th entry denotes time required for that resource to become functional after being turned on (Up Time). That is, how long of a wait is required before the resource is available for use and before being able to turn on other resource(s) that depend on that turned-on resource. Column four for an i-th entry denotes time required for that resource to shutdown or transition out of the operational state. That is, how long of a wait is required before shutting down other resource(s) that the resource depends on. The last column lists the various resource dependencies for the i-th resource.

For each i-th entry, the listed resource dependencies identify which resources need to be placed in the enabled (ON) state before the i-th resource is fully functional. For example, for resource 9 (radio LDO), resources 0, 1 and 5 need to be in the ON state. That is, for radio LDO to be fully functional, battery voltage (VBat) needs to be present, regulator module 102 needs to be in PWM mode, and regulator module 103 needs to be in PWM mode. The dependencies also operate for turning off a resource, so that in the above example, resources 0, 1 and 5 should not be turned off as long as resource 9 is in the ON state. Once resource 9 is turned OFF (lower power state), then resource 5 may be turn OFF. Resource 1 may be turned OFF, once resource 5 is OFF, since entry for resource 5 shows a dependency to resources 0 and 1.

Note that in the particular embodiment, the dependency table is set up so that the i-th entry depends only on an entry or entries that are less in number. The i-th entry does not depend on any entries of a higher resource number. Thus, table 200 has the resources and dependencies arranged in a hierarchical order. Furthermore, a variety of techniques may be employed in order to identify the dependencies in table 200. In one embodiment, a dependency map is utilized for each i-th entry, in which a bit state for a corresponding resource in the mapping identifies if that resource is a dependency for the i-th resource. The dependency mapping is typically set static (fixed), since system 100 once configured would most likely not change the dependencies. However, in other embodiments, the dependency mapping may be programmable. Additionally, the dependency mapping may take many forms and in one embodiment, bit mapping with a use of registers is used to identify the dependency criteria for each i-th entry. Also, in table 200, VBat is shown as resource 0. However, since VBat is a dependency to all of the resources, in other embodiments VBat may be treated as a required default item and not necessarily treated as a dependency for the resources.

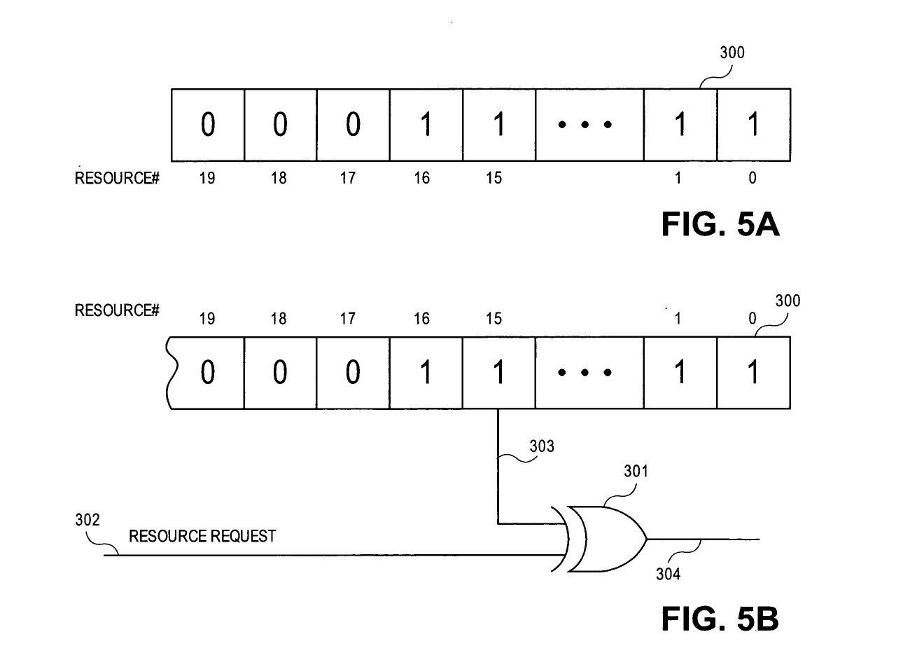

Once the dependencies are set for each entry, another mechanism is used to determine the state of each resource. Although a variety of techniques may be implemented to monitor the status of the various resources, in one embodiment, a register is used to identify the ON or OFF status of the resource entries. In FIG. 5A, an N-bit status register 300 is used to track the ON and OFF status of all the resources. ON and OFF states are determined by the bit state for each resource in register 300.

FIG. 5B shows how one entry in register 300 may be used with a request on a resource request line to initiate a mode change, ON-to-OFF or OFF-to-ON. When a request (whether to turn of or turn off) is initiated, such as from CPU, MAC or PHY of system 100, the applicable request line signal is compared with the status bit(s) for resource(s) associated with that request. PMU sequencer 101 compares the request signal with the current state status in register 300 and if the request state does not match, PMU sequencer 101 starts a process to change the state of the resource(s) pursuant to the request. A variety of techniques may be employed to check the request with the bit state of the resource. In one embodiment, an exclusive OR'ing function is used, as noted by exclusive OR (XOR) gate 301 to compare a request on line 302 and one of the bit states (e.g. bit state for resource 15 in FIG. 5B) on line 303 to obtain a change state signal on line 304. It is to be noted that FIG. 5B shows just one technique for obtaining a state change signal.

When operating with the dependency table of FIG. 4, it is appreciated that one or more resource(s) that is/are mapped as a dependency for a particular resource may further have its own dependency. Foe example, with the above described scenario for resource 9, the dependencies are resources 0, 1 and 5. However, resource 5 also has resources 0 and 1 as dependencies. Thus, for proper operation of PMU sequencer 101, resources 0 and 1 are enabled before resource 5 is disabled. Once resource 5 is fully enabled, then resource 9 may be enabled. In order to ensure that certain prerequisite resources are enabled fully in the particular mode of operation, the Up Time values of table 200 are used.

Thus, in the above example with resources 0, 1, 5, 9, if a request comes in for enabling resource 9, the resource request signal for resource 9 is checked with the status bit for resource 9 in PMU sequencer 101. If the bit state shows resource 9 to be ON, then no state transition is required since resource 9 is already on. If the bit state of resource 9 is shown to be in the OFF state, then dependencies are checked for resource 9. Since the dependencies follow a hierarchical order, the highest dependency to be checked is resource 5. If resource 5 is ON, then resource 9 may be turned on immediately. However, if resource 5 is not ON, a wait time is required to turn on resource 5. The wait time in table 200 for resource 5 is noted as approximately 500 usec. Accordingly, the Up Time for a resource in table 200 is used as a delay time for turning ON a particular dependency resource. In this example, resources 0 and 1 need not be checked since resource 5 depends on resources 0 and 1. However, if resource 5 was OFF, then the next lower dependency (which is resource 1) is checked for its status. Thus, where multiple dependencies exist in table 200 for a given entry, the ON/OFF status is checked in hierarchical order, from the highest index.

Although various techniques may be implemented, in one embodiment PMU sequencer 101 determines the list of resources that require a state change by the XOR'ing resource status with the resource request. PMU sequencer 101 then loops through the change list starting from the highest index. A particular resource may be turned ON only if all of its dependencies are already ON. If a resource is turned OFF, its dependencies are skipped until the next clock cycle. However, multiple independent resources may change state simultaneously. Therefore, after the loop, PMU sequencer 101 sets a timer whose value is set to the maximum value of the delays for each of the resource's changing states. After the timer expires, the process is repeated until PMU sequencer 101 status matches the request.

A similar scheme is used for turning OFF a given resource. In this instance, turn off delay is determined by Down Time values of table 200. The dependency works in return, so that for resource 9, resources 0, 1 and 5 may not be turned OFF, until resource 9 is turned OFF first. For resource 5, it may not be turned OFF, until other resources which depend on resource 5 as their dependency are turned to OFF first. Thus, in table 200, resources 6 and 9-19 are turned to OFF prior to turning resource 5 to OFF.

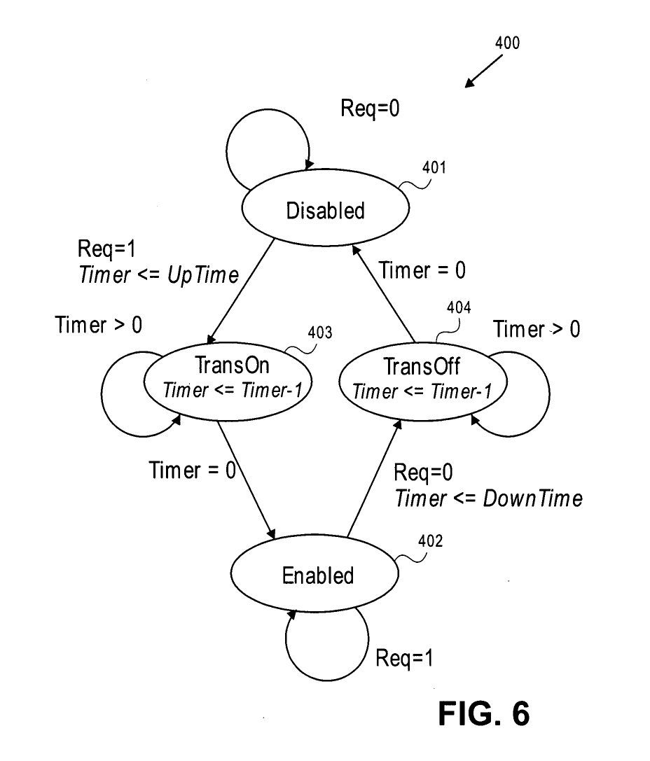

PMU sequencer 101 may use various schemes to cycle through the status of the dependent resources and allocate proper Up Time and Down Time delays to turn on or turn off the resources. One technique to achieve the dependency transitions is shown in FIG. 6. In FIG. 6, a four-state, state machine 400 is shown as one embodiment for implementing the decision process to transition between ON and OFF states for a given resource. State machine 400, which resides within PMU sequencer 101, has four states 401-404. State 401 is a disabled state, which puts a given resource into the OFF condition. State 402 is an enabled state, which puts a given resource into the ON state. TransOn state 403 is a transition state for switching from disabled state 401 to enabled state 402. TransOff state 404 is a transition state for switching from enabled state 402 to disabled state 401. TransOn state 403 uses the selected Up Time value for the delay when transitioning from disabled state 401 to enabled state 402. Likewise, TransOff state 404 uses the selected Down Time value for the delay when switching from enabled state 402 to disabled state 401.

One embodiment of an algorithm used to control state machine 400 is shown below. The requests (Req) noted below pertain to the request lines that are shown for system 100 and the current state is the state of a resource noted in register 300.

```
newReq <= 0
  for each external_req i
    newReq[i] <= 1
  for each i in MaxReq down to 0
    if newReq[i] then
      for each j in i−1 down to 0
        if reqDependsOn[i][j] then
          req[j] <= 1;
  for each i in MaxReq down to 0
    Req[i] <= CurrentState[i]
    if newReq[i] = 1 and CurrentState[i] = 0 then
      if reqDependsOn[i] AND CurrentState = reqDependsOn[i] then
        Req[i] <= 1;
    else if newReq[i] = 0 and CurrentState[i] = 1 then
      DependedOn <= 0
      For each j in MaxReq down to i+1
        if reqDependsOn[j][i] and CurrentState[j] = 1 then
          Depended On <= 1;
      if DependedOn = 0 then
        Req[i] <= 0
```

where Req[i] is the Req signal shown in the single resource state diagram.

In one embodiment, the timer state machine 400 is loaded with the Up Time or Down Time value and the timer decrements on each clock cycle. For example, in one embodiment, the timer decrements on each 32 KHz clock. When the timer reaches zero, the state transitions to ON or OFF. If the timer value is initially zero, no wait time is required and the particular state transition may occur immediately.

PMU sequencer 101 may be designed to sequence through a power determination cycle in a variety of ways. One embodiment for PMU sequencer 101 to operate through a power control cycle is the following sequence:

1. PMU sequencer computes the required resource set based on requests and the resource dependency table.

2. Decrements all timers whose values are non-zero. If a timer reaches zero, PMU sequencer clears the Resource Pending bit for the resource and inverts the Resource State bit. (A resource pending bit identifies that a resource is undergoing a transition change to change its status bit.)

3. Compares the request with the current resource status and determines which resource is to be enabled or disabled.

4. Initiates a disable sequence for each resource that is enabled, no longer being requested, and has no power up dependents.

5. Initiates an enable sequence for each resource that is disabled, is being requested and has all of its dependencies enabled.

It is appreciated that various other techniques may be implemented to provide the sequencing technique for power management of a system or device. The example system noted pertained to a wireless device. However, the power management scheme may be readily made to operate with other types of devices or in other applications. Accordingly, with selective assignment of dependencies for a system, a hierarchically ordered sequence of powering up and powering down of resources of functional modules may be achieved.

Thus, an apparatus and method to provide power management unit sequencer is described.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items.

Furthermore, the term “module” is used herein to describe a functional block and may represent hardware, software, firmware, etc., without limitation to its structure. A “module” may be a circuit, integrated circuit chip or chips, assembly or other component configurations. Accordingly, a “processing module” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions and such processing device may have accompanying memory. A “module” may also be software or software operating in conjunction with hardware.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. Similarly, flow diagram blocks and methods of practicing the embodiments of the invention may also have been arbitrarily defined herein to illustrate certain significant functionality. To the extent used, the flow diagram block boundaries and methods could have been defined otherwise and still perform the certain significant functionality. Such alternate definitions of functional building blocks, flow diagram blocks and methods are thus within the scope and spirit of the claimed embodiments of the invention. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

We claim:

1. A method comprising:
identifying functional modules that have more than one power mode state;
identifying dependencies for the functional modules, wherein the dependencies define which functional modules are hierarchically ordered for switching from a first power mode state to a second power mode state;
sequencing through the hierarchically ordered transition to place functional modules that are determined to be dependencies of a particular selected functional module into the second power mode state prior to placing the selected functional module into the second power mode state, when the selected functional module is to respond to a request to switch from the first power mode state to the second power mode state.

2. The method of claim 1, wherein during sequencing, the particular selected functional module only switches from the first power mode state to the second power mode state, when all corresponding functional module or modules identified as dependencies for the selected functional module are in the second power mode state.

3. The method of claim 2, further including identifying a first delay period for each of the functional modules, in which each first delay period is used to determine transition period from the first power mode state to the second power mode state for a corresponding functional module when the corresponding module is a dependency that is to be switched from the first power mode state to the second power mode state.

4. The method of claim 3, wherein the first power mode state is a reduced power state and the second power mode state is a fully operational power state.

5. The method of claim 3, further including sequencing through the hierarchically ordered transition to return the particular selected functional module from the second power mode state to the first power mode state, provided that no other functional module that has the selected functional module as its dependency is in the second power mode state.

6. The method of claim 5, further including identifying a second delay period for each of the functional modules, in which each second delay period is used to determine transition period from the second power mode state to the first power mode state for a corresponding functional module when the corresponding module is to be switched from the second power mode state to the first power mode state.

7. The method of claim 6, wherein a corresponding second delay period for a functional module is used by other functional modules to determine transition period of that functional module from the second power mode state to the first power mode state.

8. The method of claim 7, further including switching from a first power mode state to a second power mode state for the selected functional module and switching back from the second power mode state to the first power mode state based on a state of a request signal received for the selected functional module.

9. A method comprising:
determining functional modules that have more than one power mode state in a system;
determining dependencies for the functional modules, wherein one or more dependencies for a given functional module define which other functional module or modules are required to be in a second power mode state prior to switching the given functional module from a first power mode state to a second power mode state;
responding to a request signal to switch the given functional module from the first power mode state to the second power mode state; and
sequencing through the one or more dependencies in a hierarchical order to switch the other functional module or modules into the second power mode state prior to placing the given functional module into the second power mode state in response to the request signal.

10. The method of claim 9, further including determining a first delay period for each of the functional modules, wherein the first delay period for a corresponding functional module identifies a transition period in switching from the first power mode state to the second power mode state for that corresponding functional module and in which the first delay periods are used to determine turn-on times for corresponding functional modules when the corresponding functional modules are dependencies.

11. The method of claim 10, further including determining a second delay period for each of the functional modules, wherein the second delay period for a corresponding functional module identifies a transition period in switching from the second power mode state to the first power mode state for that corresponding functional module and in which the second delay periods are used to determine turn-off times for corresponding functional modules.

12. The method of claim 9, further including sequencing through the hierarchical order to return the given functional module from the second power mode state to the first power mode state, provided that no other functional module that has the given functional module as its dependency is in the second power mode state.

13. The method of claim 12 wherein the first power mode state is a reduced power state and the second power mode state is first operational power state.

14. The method of claim 12, wherein at least one of the functional modules has a third power state with dependencies and in which the third power state is a second operational power state.

15. An apparatus comprising:
a plurality of functional modules that have more than one power mode state in a system;
a power management module to control switching of the functional modules between at least two power mode states based on dependencies assigned to each of the functional modules, the dependencies being power mode states of one or more other functional modules, wherein the power management module sequences through the dependency or dependencies of a requested functional module that is to switch from a first power mode state to a second power mode state, in which the power management module ensures that dependency functional modules are in a second power mode state before switching the requested functional module from a first power mode state to the second power mode state.

16. The apparatus of claim 15, wherein the first power mode state is a reduced power state and the second power mode state is an operational power state.

17. The apparatus of claim 15, wherein the power management module includes a look-up table listing each of the functional modules as an entry in the look-up table and each entry having corresponding dependencies also listed in the look-up table.

18. The apparatus of claim 17, wherein at least one of the functional modules has a third power mode state with dependencies, in which the third power state is a second operational power state, the third power state with corresponding dependencies being listed in the look-up table as a separate entry from the second power mode for that functional module.

19. The apparatus of claim 17, wherein power management module includes a first delay period for each entry of the functional modules, wherein the first delay period for a corresponding functional module identifies a transition period in switching from the first power mode state to the second power mode state for that corresponding functional module and in which the first delay periods are used to determine turn-on times for corresponding functional modules when the corresponding functional modules are dependencies.

20. The apparatus of claim 19, wherein the power management module includes a second delay period for each of the functional modules, wherein the second delay period for a corresponding functional module identifies a transition period in switching from the second power mode state to the first power mode state for that corresponding functional module and in which the second delay periods are used to determine turn-off times for corresponding functional modules.
